(19) United States
(12) Patent Application Publication
(10) Pub. No.: US 2022/0163634 A1
(43) Pub. Date: May 26, 2022

(54) ACTIVE ILLUMINATION SYSTEMS FOR CHANGING ILLUMINATION WAVELENGTH WITH FIELD ANGLE

(71) Applicant: Sense Photonics, Inc., Durham, NC (US)

(72) Inventors: Alistair Souness GORMAN, Edinburgh (GB); Hod FINKELSTEIN, Berkeley, CA (US)

(21) Appl. No.: 17/612,254

(22) PCT Filed: May 27, 2020
(86) PCT No.: PCT/US2020/034633

§ 371 Date: Nov. 18, 2021

Related U.S. Application Data
(60) Provisional application No. 62/853,283, filed on May 28, 2019.

(51) Int. Cl. G01S 7/481; G01S 17/26; G01S 7/484; G01S 7/497

(52) U.S. Cl. CPC G01S 7/4815; G01S 17/26; G01S 17/93; G01S 7/497; G01S 7/484

(57) ABSTRACT

An active illumination apparatus includes an emission source configured to illuminate a field of view. The emission source includes one or more emitter elements, and is configured to output optical signals having respective wavelengths that vary based on respective portions of the field of view to be illuminated thereby. The respective wavelengths of the optical signals may vary over respective field angles of the field of view according to variations in optical characteristics of a detection module, such as a passband of a detector-side spectral filter element, for the respective field angles. Related imaging apparatus and methods are also discussed.

### CLAIM OF PRIORITY

This application claims the benefit of priority from U.S. Provisional Patent Application No. 62/853,283, filed May 28, 2019, in the United States Patent and Trademark Office, the disclosure of which is incorporated by reference herein in its entirety.

### FIELD

The present disclosure relates generally to imaging, and more specifically to active illumination-based imaging.

### BACKGROUND

Active illumination-based imaging is used in a number of applications including range finding, depth profiling, structured illumination, and 3D imaging (e.g., Light Detection And Ranging (LIDAR), also referred to herein as lidar). Time of flight (ToF) 3D imaging systems can be categorized as indirect ToF (iToF) or direct ToF systems.

Direct ToF measurement includes measuring the length of time between emitting radiation by an emitter element of a LIDAR system, and sensing the radiation after reflection from an object or other target (also referred to herein as an echo signal) by a detector element of the LIDAR system. From this length of time, the distance to the target can be determined. Indirect time of flight measurement includes measuring phase delay or phase shift of the echo signal relative to the emitted signal. The distance to the target can be calculated from the detected phase shift of the returning echo signal.

For active-illumination imaging systems with illumination sources having a relatively narrow spectral bandwidth, a narrow-band spectral filter may be used at the detector-side of the imaging optical system to reduce detection of radiation from other sources (e.g., solar or other ambient light sources) that may be incident on the detector, without inhibiting detection of light at the wavelengths of the imaging system's illumination sources. Such light from sources other than the imaging system may generally be referred to herein as background light.

### SUMMARY

Some embodiments described herein provide methods, systems, and devices including electronic circuits that provide an active-illumination-based imaging system including one or more light emitter elements (including semiconductor lasers, such as surface- or edge-emitting laser diodes; generally referred to herein as emitters) and/or one or more light detector elements (including semiconductor photodetectors, such as photodiodes, including avalanche photodiodes and single-photon avalanche detectors (SPADs); generally referred to herein as detectors).

According to some embodiments, an active illumination apparatus includes an emission source configured to illuminate a field of view. The emission source includes one or more emitter elements and is configured to output optical signals having respective wavelengths that vary based on respective portions of the field of view to be illuminated thereby.

In some embodiments, the respective portions of the field of view may include respective field angles, and the respective wavelengths of the optical signals may include a first wavelength at one or more central angles of the field angles, and a second wavelength that is greater than or less than the first wavelength at one or more peripheral angles of the field angles.

In some embodiments, the respective wavelengths of the optical signals may decrease in a stepwise or continuous fashion from the one or more central angles of the field angles to the one or more peripheral angles of the field angles.

In some embodiments, the respective wavelengths of the optical signals may vary according to variations in a passband of a detector-side spectral filter element that is configured to receive return signals having the respective wavelengths corresponding to the optical signals over the respective portions of the field of view.

In some embodiments, the apparatus may include one or more detector elements that are configured to image the field of view, and may include the detector-side spectral filter element in an optical path of the one or more detector elements. The detector-side spectral filter element may be configured to permit the return signals having the respective wavelengths that are within the passband thereof to the one or more detector elements.

In some embodiments, the detector-side spectral filter element may be configured to prevent interference with the return signals having the first wavelength that are incident thereon at the one or more central angles, and/or to prevent interference with the return signals having the second wavelength that are incident thereon at the one or more peripheral angles. For example, the detector-side spectral filter element may be configured to block the return signals having the first wavelength that are incident thereon at the one or more peripheral angles, and may be configured to block the return signals having the second wavelength that are incident thereon at the one or more central angles.

In some embodiments, the emission source may include an emitter array having a plurality of the emitter elements that are configured to emit the optical signals with the respective wavelengths that vary based on respective spatial locations of the emitter elements in the emitter array. The respective spatial locations may be arranged to illuminate the respective portions of the field of view.

In some embodiments, the emitter array may include a substrate that is non-native to the emitter elements, and the emitter elements may be assembled on the substrate at the respective spatial locations based on the respective wavelengths of the optical signals.

In some embodiments, the emitter elements may be transfer-printed on the substrate, and at least one of the emitter elements comprises a residual tether portion.

In some embodiments, each of the respective spatial locations may include a subset of the emitter elements corresponding to a same bin or a same wavelength range based on the respective wavelengths of the optical signals.

In some embodiments, the emitter elements may be light emitting diodes or laser diodes. In some embodiments, the laser diodes may be vertical cavity surface emitting laser diodes and/or edge-emitting laser diodes.

In some embodiments, the emission source may include a filter element that is in an optical path of the one or more emitter elements. The filter element may be configured to output the optical signals with the respective wavelengths that vary at respective positions along a surface of the filter element. The respective positions may be arranged to illuminate the respective portions of the field of view.

In some embodiments, the one or more emitter elements may include one or more broadband light sources that are configured to emit the optical signals having first wavelengths within a first wavelength range, and the filter element may be configured to output the optical signals having second wavelengths within respective second wavelength ranges that are narrower than the first wavelength range.

In some embodiments, the filter element may be or may include a spatially varying bandpass filter defining a non-uniform gap between one or more components thereof along an interface with the one or more emitter elements.

According to some embodiments, a method of fabricating an active illumination apparatus includes providing an emission source that is configured to illuminate a field of view. The emission source includes one or more emitter elements, and is configured to output optical signals having respective wavelengths that vary based on respective portions of the field of view to be illuminated thereby.

In some embodiments, providing the emission source may include forming an emitter array having a plurality of the emitter elements that are configured to emit the optical signals with the respective wavelengths that vary based on respective spatial locations of the emitter elements in the emitter array, where the respective spatial locations may be arranged to illuminate the respective portions of the field of view.

In some embodiments, forming the emitter array may include providing a substrate that is non-native to the emitter elements, and assembling the emitter elements on the substrate at the respective spatial locations based on the respective wavelengths of the optical signals to be emitted thereby.

In some embodiments, assembling the emitter elements may include transfer-printing the emitter elements on the substrate, and at least one of the emitter elements may include a residual tether portion.

In some embodiments, each of the respective spatial locations may include a subset of the emitter elements corresponding to a same bin or a same wavelength range based on the respective wavelengths of the optical signals.

In some embodiments, providing the emission source may include providing a filter element in an optical path of the one or more emitter elements. The filter element may be configured to output the optical signals with the respective wavelengths that vary at respective positions along a surface of the filter element, and the respective positions may be arranged to illuminate the respective portions of the field of view.

In some embodiments, the one or more emitter elements may include one or more broadband light sources that are configured to emit the optical signals having first wavelengths within a first wavelength range, and the filter element may be configured to output the optical signals having second wavelengths within respective second wavelength ranges that are narrower than the first wavelength range.

In some embodiments, the method may further include providing a detection module having one or more detector elements that are configured to receive return signals having the respective wavelengths corresponding to the optical signals over the respective portions of the field of view, and a detector-side spectral filter element in an optical path of the one or more detector elements. The respective wavelengths of the optical signals may vary according to variations in a passband of the detector-side spectral filter element.

In some embodiments, the respective portions of the field of view may include respective field angles. The respective wavelengths of the optical signals may include a first wavelength at one or more central angles of the field angles, and a second wavelength that is greater than or less than the first wavelength at one or more peripheral angles of the field angles. The detector-side spectral filter element may be configured to block the return signals having the first wavelength that are incident thereon at the one or more peripheral angles, and may be configured to block the return signals having the second wavelength that are incident thereon at the one or more central angles.

According to some embodiments, an active illumination-based imaging apparatus includes an emission source and a detection module. The emission source includes one or more emitter elements configured to output optical signals to illuminate a field of view, and the detection module includes one or more detector elements configured to image the field of view. The emission source is configured to output the optical signals having respective wavelengths that vary over respective field angles of the field of view according to variations in optical characteristics of the detection module for the respective field angles.

In some embodiments, the respective wavelengths may include a first wavelength at one or more central angles of the field angles, and a second wavelength that is greater than or less than the first wavelength at one or more peripheral angles of the field angles.

In some embodiments, the respective wavelengths may decrease in a stepwise or continuous fashion from the one or more central angles of the field angles to the one or more peripheral angles of the field angles.

In some embodiments, the detection module may further include a spectral filter element in an optical path of the one or more detector elements and configured to permit return signals having the respective wavelengths within a passband thereof to the one or more detector elements. The optical characteristics of the detection module may include the passband of the spectral filter element for the respective field angles.

In some embodiments, the spectral filter element may be configured to block the return signals having the first wavelength that are incident thereon at the one or more peripheral angles, and may be configured to block the return signals having the second wavelength that are incident thereon at the one or more central angles.

In some embodiments, the emission source may include an emitter array comprising a plurality of the emitter elements that are configured to emit the optical signals with the respective wavelengths that vary based on respective spatial locations of the emitter elements in the emitter array, wherein the respective spatial locations are arranged to illuminate the respective field angles. Additionally or alternatively, the emission source may include a filter element that is in an optical path of the one or more emitter elements and is configured to output the optical signals with the respective wavelengths that vary at respective positions along a surface of the filter element, wherein the respective positions are arranged to illuminate the respective field angles.

In some embodiments, at least one control circuit may be configured to control the emission source and/or the detection module (e.g., by controlling respective temperatures thereof) to vary the respective wavelengths of the optical signals over the respective field angles and/or to control the variations in the optical characteristics of the detection module for the respective field angles.

Other devices, apparatus, and/or methods according to some embodiments will become apparent to one with skill in the art upon review of the following drawings and detailed description. It is intended that all such additional embodiments, in addition to any and all combinations of the above embodiments, be included within this description, be within the scope of the invention, and be protected by the accompanying claims.

### BRIEF DESCRIPTION OF THE DRAWINGS

FIG. 1 is a block diagram illustrating an example lidar system or circuit in accordance with some embodiments of the present disclosure.

FIGS. 2A and 2B are schematic diagrams illustrating examples of illumination of a field of view to provide field angle-dependent variation in emission wavelength in accordance with some embodiments of the present disclosure.

FIGS. 3A and 3B illustrate an emitter array including emitters configured to output respective optical signals having different emission wavelengths according to position in the array in accordance with some embodiments of the present disclosure.

FIG. 3C illustrates an emission source including one or more emitters with an emitter-side filter element that is configured to output respective optical signals having emission wavelengths that vary with field angle in accordance with some embodiments of the present disclosure.

FIGS. 4A and 4B illustrates an example implementations of a detector-side filter element that is configured to selectively accept respective optical signals having emission wavelengths that vary with field angle and one or more detectors that are configured to image the field of view in accordance with some embodiments of the present disclosure.

FIG. 5 is a block diagram illustrating example operations of active illumination systems including emission sources and detection modules that are configured to operate based on field angle- or position-dependent variation in emission wavelength in accordance with some embodiments of the present disclosure. FIG. 6A is a graph illustrating example passband characteristics of a detector-side filter in coordination with operation of emission sources in accordance with some embodiments of the present disclosure.

FIG. 6B is a graph illustrating example passband characteristics of a detector-side filter in coordination with operation of emission sources in accordance with some further embodiments of the present disclosure.

FIG. 6C is a graph illustrating example passband characteristics of a detector-side filter in coordination with operation of emission sources in accordance with yet further embodiments of the present disclosure.

FIG. 7 is a graph illustrating an example of the expected shift in passband of a detector-side filter with angle of incidence.

FIG. 8 is a graph illustrating differences or shifts in passband with angles of incidence for an example interference-type detector-side filter.

FIG. 9 a graph illustrating differences in filter diameter requirements over a field of view.

FIGS. 10A and 10B are graphs illustrating effects of reducing the field or pupil angles of an optical system and corresponding changes in detector-side filter size compared to the use of the filter at the aperture stop.

### DETAILED DESCRIPTION

In the following detailed description, numerous specific details are set forth to provide a thorough understanding of embodiments of the present disclosure. However, it will be understood by those skilled in the art that the present disclosure may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Some embodiments of the present disclosure are described herein with reference to lidar applications and systems. A lidar system may include an array of emitters and an array of detectors, or a system having a single emitter and an array of detectors, or a system having an array of emitters and a single detector. As described herein, one or more emitters may define an emitter unit, and one or more detectors may define a detector pixel. A flash lidar system may acquire images by emitting light from an array, or a subset of the array, of emitter elements for short durations (pulses) over a field of view or scene. A non-flash or scanning lidar system may generate image frames by raster scanning light emission (continuously) over a field of view or scene, for example, using a point scan or line scan to emit the necessary power per point and sequentially scan to reconstruct the full field of view.

While described herein primarily with reference to application in lidar systems, it will be understood that embodiments of the present disclosure is in no way limited to lidar applications. For example, embodiments of the present disclosure may be used in security cameras (e.g., using infrared (IR) illumination for imaging in darkness), military applications (e.g., in missile guidance), and/or other imaging systems using active illumination (e.g., to prevent blinding of an illuminating source), whether in the visible wavelength ranges or outside of the visible spectrum (e.g., IR-based imaging). More generally, embodiments of the present disclosure may be applied to any active illumination system where removal of non-active illumination or energy may be desired.

An example of a ToF measurement system or circuit 100 in a LIDAR application including active illumination systems that may operate in accordance with embodiments of the present disclosure is shown in FIG. 1. The lidar system or circuit 100 includes a control circuit 105 and a timing generator or driver circuit 116 that control timing of an illumination or emission source 15 (illustrated as including emitter array 115 comprising a plurality of emitters 115e) and a detection module 10 (illustrated as including a detector array 110 comprising a plurality of detectors 110d). The detectors 110d include time-of-flight sensors (for example, an array of single-photon detectors, such as SPADs). One or more of the emitter elements 115e of the emitter array 115 may define emitter units that respectively emit optical illumination pulses or continuous wave signals (generally referred to herein as optical signals, emitter signals, or light emission) at a time and frequency controlled by the timing generator or driver circuit 116. In particular embodiments, the emitters 115e may be pulsed light sources, such as LEDs or lasers (such as vertical cavity surface emitting lasers (VCSELs)). The optical signals are reflected back from a target 150, and sensed by detector pixels defined by one or more detector elements 110d of the detector array 110. The control circuit 105 may implement a pixel processor that measures and/or calculates the time of flight of the illumination pulse over the journey from emitter array 115 to target 150 and back to the detectors 110d of the detector array 110, using direct or indirect ToF measurement techniques.

The driver electronics 116 may each correspond to one or more emitter elements, and may each be operated responsive to timing control signals with reference to a master clock and/or power control signals that control the peak power of the light output by the emitter elements 115e, for example, by controlling the peak drive current to the emitter elements 115e. In some embodiments, each of the emitter elements 115e in the emitter array 115 is connected to and controlled by a respective driver circuit 116. In other embodiments, respective groups of emitter elements 115e in the emitter array 115 (e.g., emitter elements 115e in spatial proximity to each other), may be connected to a same driver circuit 116. The driver circuit or circuitry 116 may include one or more driver transistors configured to control the modulation frequency, timing, and amplitude/power level of the optical signals that are output from the emitters 115e, also referred to as optical emission signals.

An emitter-side filter element 113 (for example, a Fabry-Perot interferometer), a diffuser 114, and a prism or grating 214 (generally referred to herein as illumination optics) are also illustrated, for example, to increase and/or tailor light output over a field of view of the emitter array 115. The illumination optics can be configured to provide a sufficiently low beam divergence of the light output from the emitter elements 115e so as to ensure that fields of illumination of either individual or groups of emitter elements 115e do not significantly overlap, and yet provide a sufficiently large beam divergence of the light output from the emitter elements 115e to provide eye safety to observers.

The sensing or detection of the light reflected from the target(s) 150 illuminated by the light output from the emitter elements 115e is performed using a receiver/detection module or circuit 10, including a detector array 110. In some embodiments, the detector array 110 includes an array of detector pixels (with each detector pixel including one or more detectors 110d, e.g., single-photon detectors, such as Single Photon Avalanche Diodes (SPADs)). SPAD-based detector arrays may be used as solid-state detectors in imaging applications where high sensitivity and timing resolution are desired. Receiver optics 112 (e.g., one or more lenses to collect light over the FOV 190), and receiver electronics (including timing circuit 106) are configured to power, enable, and disable all or parts of the detector array 110 and to provide timing signals thereto. The detector pixels can be activated or deactivated with at least nanosecond precision, and may be individually addressable, addressable by group, and/or globally addressable. The receiver optics 112 may include a macro lens that is configured to collect light from the largest FOV 190 that can be imaged by the lidar system, microlenses to improve the collection efficiency of the detecting pixels, and/or anti-reflective coating to reduce or prevent detection of stray light.

The detectors 110d of the detector array 110 are connected to the timing circuit 106. The timing circuit 106 may be phase-locked to the driver circuitry 116 of the emitter array 115. The sensitivity of each of the detectors 110d or of groups of detectors may be controlled. For example, when the detector elements include reverse-biased photodiodes, avalanche photodiodes (APD), PIN diodes, and/or Geiger-mode Avalanche Diodes (SPADs), the reverse bias may be adjusted, whereby, the higher the overbias, the higher the sensitivity. When the detector elements 110d include integrating devices such as a CCD, CMOS photogate, and/or photon mixing device (pmd), the charge integration time may be adjusted such that a longer integration time translates to higher sensitivity.

As shown in FIG. 1, a spectral filter 111 (also referred to herein as a detector-side filter element or filter) may be provided in the optical path of the detector(s) 110d. The detector-side filter 111 may permit ‘signal’ light of the wavelength range(s) corresponding to the light emission output from the emitters 115e to pass through to the detector(s) 110d (i.e., to allow passage of light corresponding to the passband of the detector-side filter 111), and block or prevent passage of non-signal or background light (of wavelengths different than the optical signals output from the emitters, which is outside the passband of the detector-side filter 111). It may thus be advantageous for the passband of the detector-side filter 111 to be as narrow as possible, in order to increase or maximize background light rejection.

Light emission from one or more of the emitters 115e impinges on and is reflected by one or more targets 150, and the reflected light is detected as an optical signal (also referred to herein as a return signal, echo signal, or echo) by one or more of the detectors 110d (e.g., via one or more lenses 112, mirrors, and/or detector-side filter elements 111, generally referred to herein as collection optics), converted into an electrical signal representation, and processed (e.g., based on time of flight) to define a 3-D point cloud representation 170 of the field of view 190. The emission field maps wavelength to angle with respect to the normal or optical axis of the emission source 15. In some embodiments, the emission source 15 may include more than one emitter element 115e, each having a different emission wavelength, a diffuser 114 configured to sufficiently homogenize the emission field of the combined spectrum output from the emitter elements 115e, an optical element 214 (such as a prism or grating) configured to direct different spectral components or wavelengths at different directions or angles over the field of view 190, and optionally additional optics to control the divergence angle of the emitted beams/optical signals. In embodiments described herein, the divergence angle of the beams/optical signals may be maintained sufficiently narrow so that the wavelength-to-angle mapping is maintained in the far field, while still maintaining eye safety. Operations of lidar systems 100 in accordance with embodiments of the present disclosure may be performed by one or more processors or controllers, such as the control circuit 105 shown in FIG. 1.

Some embodiments described herein may arise from realization that, when a detector-side filter 111 is used in the optical path of the detector(s) 110d, there can be a shift in the passband of the detector-side filter 111 with the angle of incidence of light thereon. For example, for an interference-type detector-side filter (e.g., a flat dielectric filter with the same pass band across the filter aperture), the shift in the passband may be due to the changing path length through the detector-side filter material with the angle of incidence. That is, the wavelengths of light that are permitted to pass through the detector-side filter 111 for detection by the detector(s) 110d may vary with the angle of the incident light on the surface of the filter 111 (also referred to herein as incidence angle or angle of incidence (AOI)). As described herein, incidence angles at or on a filter 111 are defined relative to the optical axis of the filter 111 (which may be orthogonal to a surface of the filter 111).

In particular, as the angle of a collimated beam is tilted away from a normal surface of an optical interference filter, the transmission spectrum may be “blue shifted,” i.e., the spectral features may shift to shorter wavelengths. This angle shift becomes more pronounced with increasing angle of incidence, and can be calculated in collimated light and for relatively small angles of incidence using the following formula:

$${λ}_{θ} = {λ}_{o} \sqrt{1 - {( \frac{{n}_{o}}{{n}_{eff}} sin θ )}^{2}}$$

where λ_{θ} is the wavelength corresponding to the feature of interest at incident angle θ; λ₀ is the wavelength corresponding to the feature of interest at normal incidence; n₀ is the refractive index of incident medium; and n_{eff} is the effective refractive index of the optical filter. In some embodiments, objects can be approximated to be at infinity, reflected light arriving from an object at an angle θ (an azimuthal angle in a 3-D FoV) will only be transmitted through the filter if the wavelengths of the reflected light satisfy the above equation.

FIG. 7 is a graph illustrating an example of the expected shift in passband of a detector-side filter with angle of incidence. As shown in the example of FIG. 7, a detector-side filter with an effective refractive index of 1.75 has a passband 705 of about 5 nanometers (nm) (where the passband 705 is defined between lower curve/cut on wavelength 701 and upper curve/cut off wavelength 702) that is centered on 937 nm at an incident angle of 0 degrees. The area between the cut on wavelength 701 and the cut off wavelength 702 illustrates the changes in passband for the detector-side filter over a range of incidence angles of 0 to 10 degrees. FIG. 7 also illustrates the emission bandwidth for a 2 nm wide optical signal 715 output from an emission source, with a center wavelength of about 937 nm. As shown in FIG. 7, above an incidence angle of about ±6 degrees (or ±7 degrees if the source and cut-on wavelength are closer together), the optical signal 715 output from the emission source begins to be attenuated by the filter.

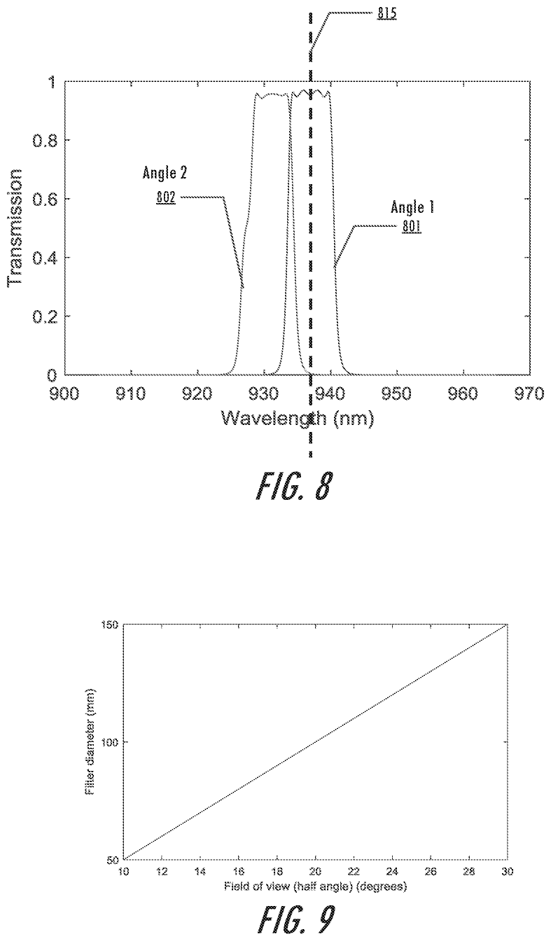

FIG. 8 is a graph illustrating differences or shifts in passband with angle of incidence for an example interference-type detector-side filter. In particular, FIG. 8 illustrates wavelength vs. amount of light transmission to illustrate a typical difference or shift in passband at two angles of incidence (Angle 1 801 and Angle 2 802) for an example interference-type detector-side filter. As shown in FIG. 8, incident light 815 having the wavelength indicated by the dashed line (e.g., a wavelength of about 937 nm) may not be passed by the filter if incident at Angle 2 802 relative to the optical axis of the filter, due to the ±6 to 7 degree shift in the passband at Angle 2 802 vs. Angle 1 801.

As noted above, it may be advantageous for the passband of the detector-side filter to be as narrow as possible, in order to increase or maximize background light rejection. To ensure that the passband of the detector-side filter is suitably narrow for blocking of the background light the beam sizes in the optical system may be magnified (e.g., using additional lenses/collection optics) to reduce the incidence angle at the detector-side filter surface. However, for a system with a large entrance aperture and large field of view, this beam magnification can lead to the filter aperture (and thus, the overall optical system) becoming prohibitively large in size. For example, if the imaging system has a field of view of θ, and an entrance aperture of α for the desired f-number (i.e., the ratio of focal length to diameter of the entrance aperture, expressed as f/n) and magnification, and the filter acceptance angle is φ, then the filter aperture F diameter scales as:

$$F = \frac{θ}{φ} a$$

FIG. 9 is a graph illustrating filter diameter F requirements (in millimeters (mm)) for an f/1 system (i.e., with an f-number of 1) from +/−10 to +/−30 degrees field of view for a α=25 mm entrance aperture and a filter acceptance angle of 5 degrees.

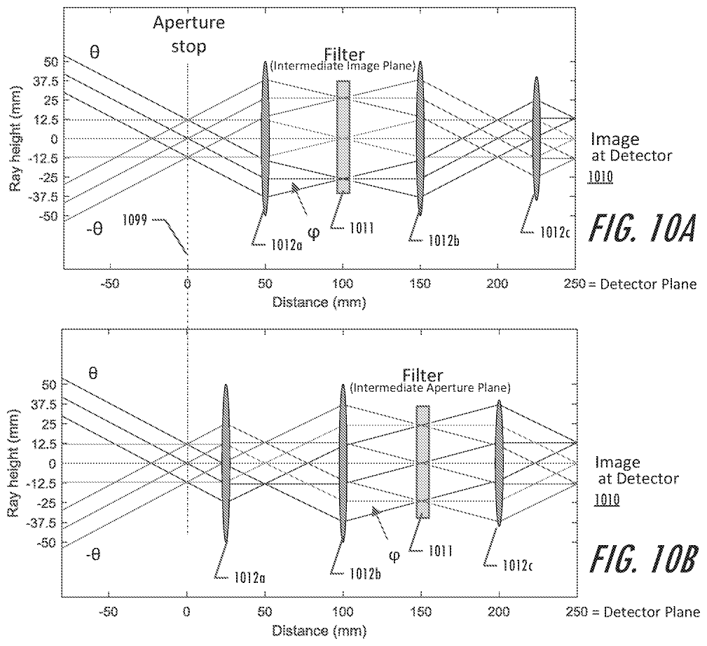

FIGS. 10A and 10B are graphs illustrating effects of reducing the field or pupil angles through the detection-side of an optical system (and the corresponding increase in detector-side filter size) compared to the use of the filter at the aperture stop 1099. At the detector side, field angle may refer to the angle defined by a ray from a point in the field with respect to the optical axis of the detection system (which is along the y-axis in FIGS. 10A and 10B). Each field point typically reflects light into a cone angle or solid angle, a portion of this solid angle intersects with the optical system (illustrated as lenses 1012a, 1012b, 1012c) and the light from within this portion is focused onto an image plane in the system. An image plane may refer to any plane in the system where the light for a single field angle is brought to focus. The size of the corresponding solid angle at an image plane can depend on the magnification at this image plane. An aperture plane may refer to a plane in the system for which the chief rays for all fields intersect with each other and with the optical axis of the system. The range of angles at an aperture plane may depend on the magnification of the beam size at this aperture plane.

In FIG. 10A, an optical system including a combination of lenses 1012a, 1012b, 1012c and an interference filter 1011 is used to produce an intermediate image plane (indicated by the light focused at the illustrated interference filter 1011) that is larger than the detector plane (i.e., the light receiving surface of the detector), making the solid angle at this image plane for each field position smaller than the corresponding solid angle at the detector plane. The interference filter 1011 can be placed at this intermediate image plane with a smaller range of incident angles, further optics 1012b, 1012c can be used to demagnify this image plane onto the detector 1010.

In FIG. 10B, an optical system including a combination of lenses 1012a, 1012b, 1012c and an interference filter 1011 is used to produce an intermediate aperture plane (at the illustrated interference filter 1011) that is larger than the beam diameter entering the system, making the range of angles at this intermediate aperture plane smaller than the range of field angles. The interference filter 1011 can be placed at this intermediate aperture plane with a smaller range of incident angles, and further optics 1012c can be used to focus the collimated beams through this intermediate aperture onto the detector 1010.

As noted above, a drawback of narrowband dielectric filters is their narrow acceptance angle (low numerical aperture), which limits the light throughput of the system. Light throughput or Etendue (which may be based on the product of an aperture area and the numerical aperture) should be conserved in a system in order to reduce energy loss. A system which is light starved (e.g., due to the limited emitter power or low reflectivity of an object or long range of an object) may require a relatively large collection aperture. The Etendue may also be relatively large for a wide field of view. In the filter plane, the numerical aperture may be relatively small, so to maintain Etendue may require the filter aperture to be very large, thereby increasing size and expense.

Some embodiments described herein are directed to improving performance in active illumination-imaging systems that utilize narrow-passband detector-side filters (e.g., having passbands of less than about 15 nm, less than about 10 nm, less than about 5 nm, or less than about 3 nm), without restricting the field of view, without restricting the numerical aperture of the system, and without the detector-side filter and optical system becoming prohibitively large. Some conventional approaches may include using a suitable absorption filter, reducing the field of view, reducing the numerical aperture of the system, increasing the aperture size of the filter, and/or use of a curved filter substrate.

In contrast, some embodiments described herein may address the above and/or other problems by configuring an optical emission source 15 (including but not limited to the emitter elements 115e of an emitter array 115 and/or other emitter-side optical elements, including emitter-side lenses and/or emitter-side filters 113) such that the illumination wavelengths (also referred to herein as emission wavelengths) output from the emission source 15 vary with angle over the field of view, in some embodiments based on variations in optical characteristics (e.g., variations in passband) of an optical detection module 10 (including but not limited to the detector-side lenses 112, detector-side filters 111, and/or other detection-side optical elements) for corresponding angles over the field of view. As described herein, the field of view may refer to an angular range (e.g., 180 degrees) that is illuminated by an emission source and/or imaged by a detection module relative to a respective optical axis of the emission source and/or detection module. The FOV may include respective angles, also referred to herein as “field angles,” as well as angular ranges or sub-ranges including one or more of the field angles, relative to the optical axis of the emission source and/or detection module.

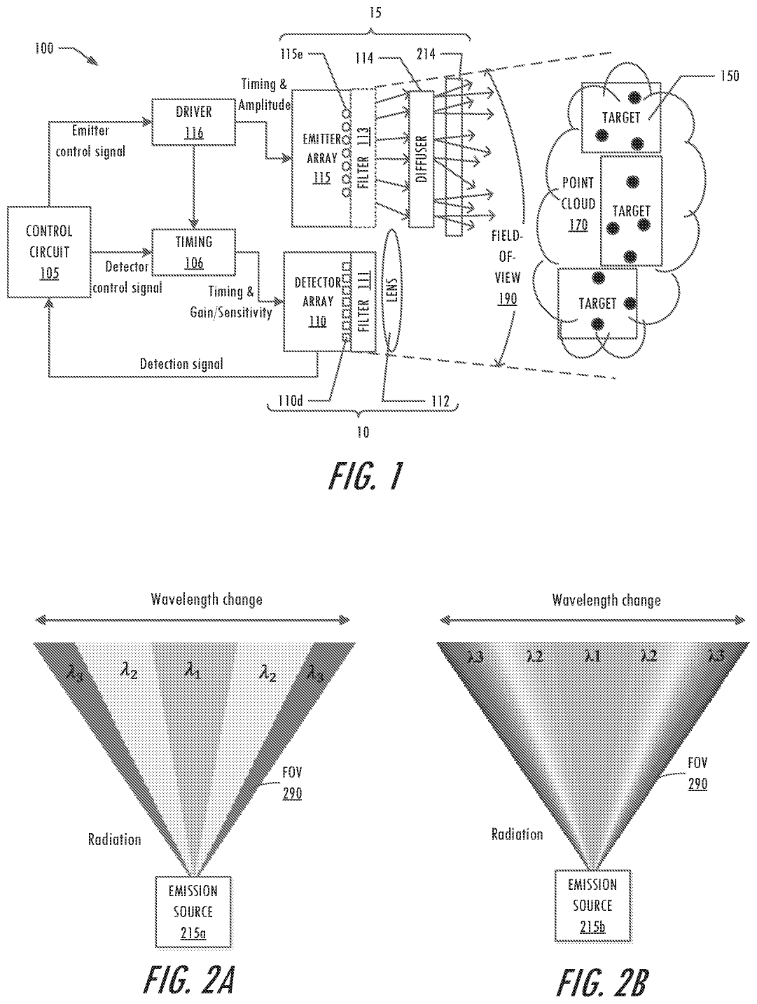

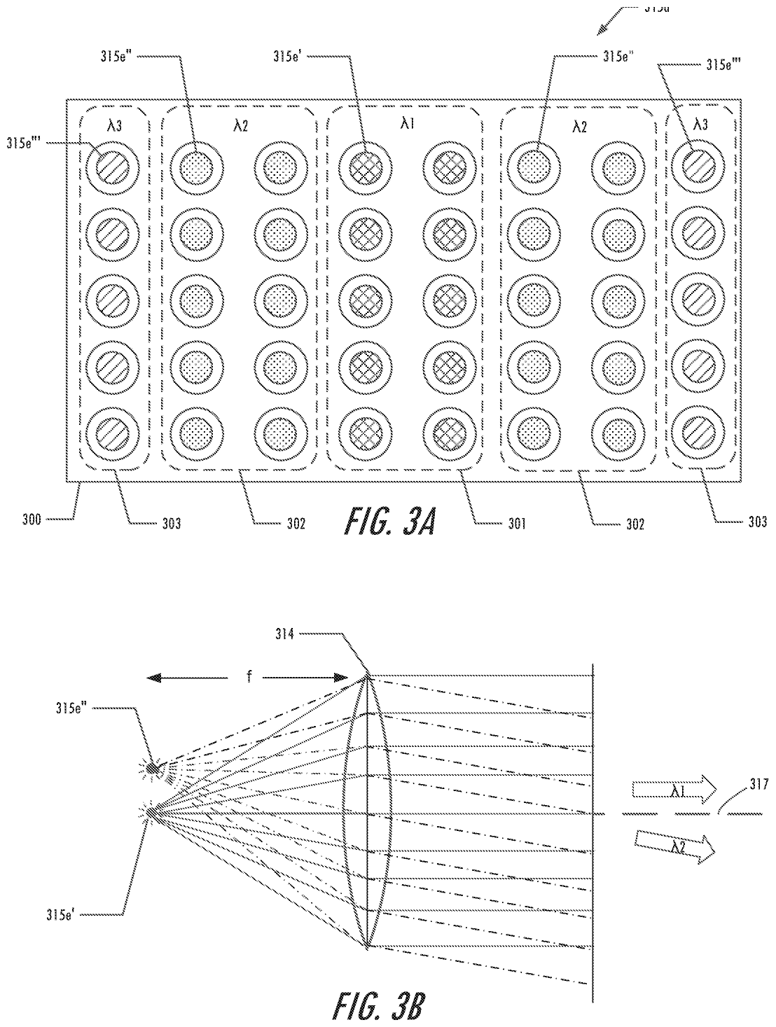

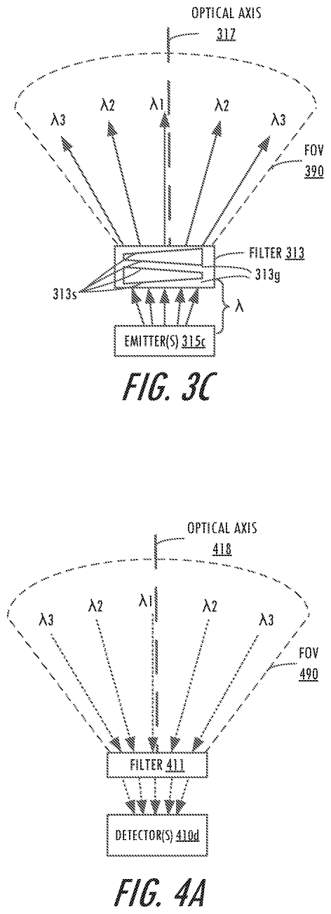

In some embodiments, the wavelengths of light output from the emission sources can be configured to vary at each field angle of the FOV, as shown in FIGS. 2A and 2B, so as to match or otherwise correspond to the passband of a detector-side filter for that field angle of the FOV, for example, by arranging emitters that output different wavelengths of light in different portions of the emitter array. Some methods and devices for forming a wavelength-directional emission source are shown by way of example in FIGS. 3A and 3B. Multiple sufficiently small emission sources are placed at the focal plane f of a lens. The rays emanating from each emitter 315e′, 315e″ will be collimated by the lens 314 with the chief ray angle corresponding to the distance of each emitter 315e′, 315e″ from the optical axis. For example, if the emitters are VCSELs and the wavelength of the center VCSEL is longer than that of the peripheral VCSEL, then the 0 degree direction will be illuminated with optical signals of a longer wavelength than the peripheral direction.

Other methods and devices for forming wavelength-directional emission source are shown by way of example in FIG. 3C, by arranging one or more optical elements 313 (such as a spatially-varying bandpass filter element) in the optical path of the emitter array 315c. Such a filter element may be less energy-efficient because the filter element may not transmit light outside the pass band of the filter. In another embodiment, an optical element 313 may be a prism, diffraction grating or another similar element that is placed in the optical path of the emitters 315c such that different spectral components are directed to different directions and all the energy within the spectral band of interest is used to illuminate the target. The spectral distribution may be symmetrical with respect to the optical axis of the receiver or detection module, as explained below.

In some embodiments described herein, the emission source may be configured to output optical signals having an angle-dependent spectrum following the angle shift equation discussed above, so that the emission angular spectrum matches the angular spectrum of the detector-side filter, thereby effectively increasing the acceptance angle of the detector-side filter. The detector-side filter aperture can therefore be made smaller for the same filter bandwidth (e.g., the same passband) as compared to a system with a fixed wavelength of emission for all fields or portions of the field of view. This variation in illumination wavelength can be continuous, or can be discrete with bands or zones of different wavelength steps.

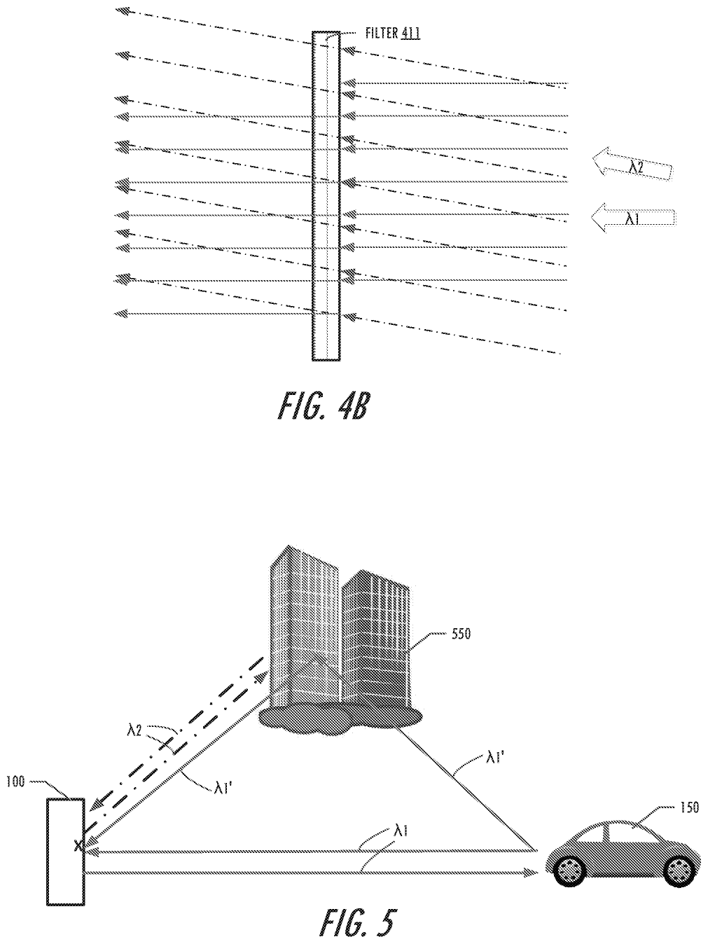

In some embodiments, the passband of the detector-side filter may be configured to vary so as to match or otherwise correspond to the wavelengths of light output from the emission sources at each field angle of the FOV. That is, the detector-side filter may be configured and positioned to transmit light having the same correspondence between wavelength and direction as the light output from the emission source. For example, as shown in FIGS. 4A and 4B, a spectral filter element 411 having a passband that varies with different angles of incidence may be used independent of or in combination with the varying wavelengths of light from the emission sources, such that light at each field angle of the FOV can be matched or otherwise correspond to the varying passband of a detector-side filter for that field angle of the FOV.

FIGS. 2A and 2B are schematic diagrams illustrating examples of illumination of a field of view to provide field angle-dependent variation in emission wavelength in accordance with embodiments described herein. In particular, FIG. 2A illustrates an emission source 215a that is configured to provide discrete or stepwise variations of emission wavelength (including respective emission wavelengths λ1, λ2, λ3) over respective field angles of the FOV 290, while FIG. 2B illustrates an emission source 215b that is configured to provide a continuous variation of emission wavelength with field angle (where the shading illustrates continuous variation between a wavelength range of λ1 to λ3) over the FOV 290. The stepwise or continuous variation in the emission wavelengths may be achieved mechanically and/or optically. For example, in some embodiments, the discrete or stepwise variation in emission wavelength may be implemented mechanically, e.g., by arranging respective groups of emitters 115e to illuminate respective portions or field angles of the FOV 290, with each emitter 115e configured to emit light with a respective one of the emission wavelengths λ1, λ2, λ3. In some embodiments, the continuous variation in emission wavelength over the FOV 290 may be implemented optically, e.g., by arranging a spatially varying bandpass filter in the optical path of the emitter(s) 115e. The emission sources 215a, 215b may include or otherwise represent one or more of the emission sources 113, 114, and/or 115 of FIG. 1.

In FIGS. 2A and 2B, the emission sources 215a, 215b emit light having a wavelength of λ1 over a central angle or portion of the FOV, light having a wavelength of λ3 over peripheral angles or portions of the FOV, and light having a wavelength of λ2 over angles or portions of the FOV between the central and peripheral angles. The wavelength λ1 may be greater than the wavelength λ2, and the wavelength λ2 may be greater than the wavelength λ3. The field angle-dependent variation in emission wavelength provided by the emission sources 215a, 215b may be selected based on or may otherwise correspond to the field angle-dependent passband characteristics of a detector-side filter, such as the filter 111 of FIG. 1. Three emission wavelengths λ1, λ2, λ3 are illustrated by way of example only, and it will be understood that embodiments of the present disclosure may include emission sources that are configured to output fewer or more wavelengths of light emission that vary with field angle over a desired emission wavelength range.

FIGS. 3A and 3B illustrate an emission source including an emitter array 315a comprising emitters 315e and optical elements 314 configured to output respective optical signals having different emission wavelengths according to position in the array 315a in accordance with some embodiments described herein. The emitter array 315a and emitters 315e may include or otherwise represent the emitter array 115 and emitters 115e of FIG. 1. In particular, FIGS. 3A and 3B may illustrate an example implementation of the emission source 215a that provides the discrete variations in emission wavelength shown in FIG. 2A.

As shown in FIG. 3A, the emitter array 315a includes a plurality of emitter elements 315e′, 315e″, 315e′″ (collectively 315e) arranged to output respective optical signals with respective wavelengths that differ based on respective spatial locations 301, 302, 303 of the emitter elements 315e in the emitter array 315a. In particular, emitters 315e′ that are configured to output optical signals of a first wavelength λ1 are arranged at positions in a central or first region 301 of the emitter array 315a; emitters 315e″ that are configured to output optical signals of a second wavelength λ2 are arranged at positions in second regions 302 of the emitter array 315a that are peripheral to the first region 301; and emitters 315e′″ that are configured to output optical signals of a third wavelength λ3 are arranged at positions in third regions 303 of the emitter array 315a that are peripheral to both the second regions 302 and the first region 301.

The emitter elements 315e are assembled or otherwise arranged at the spatial locations 301, 302, 303 in the emitter array 315a such that the different emission wavelengths λ1, λ2, λ3 vary over portions or angles of the field of view which the spatial locations 301, 302, 303 are arranged to illuminate, for instance, so as to correspond to variations in a passband of a detector-side spectral filter (such as filter 111 of FIG. 1) over corresponding portions or angles of the field of view imaged by the detector (such as the detection module 10 of FIG. 1). That is, emitters 315e′, 315e″, and 315′″ having different emission characteristics may be grouped and assembled at respective regions 301, 302, and 303 of the emitter array 315a based on passband characteristics of detection-side optical elements, such that different wavelengths of light reflected from targets at respective portions of the field of view are received at respective angles of incidence that correspond to the variations in the passband of the detection-side optical elements.

The different emission wavelengths λ1, λ2, λ3 of the light output from the emitters 315e may be measured individually or in groups for arrangement in the emitter array 315a. In some embodiments, the emitters 315e may be grouped or ‘binned’ based on their respective emission wavelength λ1, λ2, λ3. The emitters 315e may be narrowband light sources, with differences between the emission wavelengths λ1, λ2, λ3 that are relatively small (for example, within a few nanometers of one another), as the detector-side filter's passband may only vary by a few nanometers as angles of incidence increase. For example, emitters 315e′ with nominal emission wavelengths (at room temperature) of 930-931 nm may be provided from one bin associated with emission wavelength λ1, emitters 315e″ with emission wavelengths of 931-932 nm may be provided from another bin associated with emission wavelength λ2, and emitters 315e′″ with emission wavelengths of about 932-933 nm may be provided from still another bin associated with emission wavelength λ3, etc. That is, the different emission wavelengths λ1, λ2, λ3 may respectively represent a wavelength range of less than 3 nm, less than 2 nm, or even about 1 nm or less. Emitters from the different bins associated with emission wavelengths λ1, λ2, λ3 may be attached to a common substrate 300 with a spatial arrangement as shown in FIG. 3A, and may be electrically interconnected on the common substrate to provide the emitter array 315a.

In some embodiments, the emitters 315e may be diced from individual wafers or from different locations on a same wafer, and may be attached and electrically interconnected onto the common substrate 300. That is, the common substrate 300 on which the emitters 315e are assembled may be a non-native substrate, which is different than the respective substrates on which the emitters 315e were formed. In some embodiments, the emitters 315e may be picked and placed on the common substrate 300 using Micro Transfer Printing (MTP) techniques. As such, one or more of the emitters 315e may include residual tether portions that previously anchored the emitters 315e to a source substrate or wafer prior to the MTP process. Fabrication of emitter arrays using such MTP techniques is described in U.S. Patent Application Publication No. 2018/0301872 to Burroughs et al., the disclosure of which is incorporated by reference herein in its entirety. In some embodiments, the emitters 315e may be first attached to a substrate such as a printed circuit board, and then placed on the common substrate 300 with a spatial arrangement as shown in FIG. 3A and electrically connected to driver/control circuitry and a power supply.

In some embodiments, the emitter array 315a may include an array of light emitting diodes as the emitters 315e. In some embodiments, the emitter array 315a may include an array of vertical cavity surface emitting lasers (VCSELs) as the emitters 315e. In some embodiments, the emitter array 315a may include an array an array of side- or edge-emitting laser diodes as the emitters 315e. Where the emitters 315e are VCSELs or LEDs, the respective emission wavelengths may be mapped to the emitters 315e on or at the wafer level, e.g., using a wafer probe system to determine the respective emission wavelength of each emitters 315e.

As shown in FIG. 3B, the emitters (shown with reference to two emitters 315e′, 315e″ for ease of illustration) are arranged at the focal plane f of a lens 314. The optical signals emitted from each emitter 315e′, 315e″ is collimated by the lens 314, with the chief ray angle corresponding to the distance of each emitter 315e′, 315e″ from the optical axis 317. For example, where the emitters 315e′, 315e″ are VCSELs and the wavelength of the centrally arranged VCSELs 315e′ are longer than that of the peripheral VCSELs 315e″, the 0 degree direction may be illuminated with optical signals of a longer wavelength (λ1) than the wavelengths (λ2) of the optical signals that are output to illuminate one or more peripheral direction(s).

FIG. 3C illustrates an emission source including one or more emitters 315c with an emitter-side filter element 313 that is configured to output respective optical signals having emission wavelengths that vary with angle over a FOV 390 in accordance with some embodiments described herein.

The emitter(s) 315c and emitter-side filter 313 may include or otherwise represent the emitters 115e and filter 113 of FIG. 1. In particular, FIG. 3B may illustrate an example implementation of the emission source 215b that provides the continuous variations in emission wavelength shown in FIG. 2B. The emitter(s) 315c may include one or more LEDs, VCSELs, or other emitters described above with reference to the emitter array 315a. For example, the emitter(s) 315c may include a broadband light source that provides light emission over a wavelength range of about 8 nm or more in some embodiments, while a narrowband light source may provide light emission over a wavelength range of about 2 nm or less. However, it will be understood that example ranges defining broadband versus narrowband may vary in embodiments described herein depending on application, field of view, and/or portion of the electromagnetic spectrum of the light emission. For example, in embodiments where the light emission from the emitter(s) 315c is in the 530 nm range, an emitter-side filter 313 that is 3 to 6 times narrower than embodiments where the light emission from the emitter(s) 315c is in the 940 nm range may be used, and the range of wavelengths corresponding to broadband and narrowband emission may differ from those mentioned above.

In some embodiments, the emitter-side filter 313 may be a linearly varying filter that is configured to provide discrete or continuously varying spectral properties alone one or more dimensions of the filter 313. In FIG. 3C, the emitter-side filter 313 is illustrated as a spatially-varying bandpass filter, for example, a Fabry-Perot filter (e.g., based on Fabry-Perot reflections from multiple discrete interfaces) and/or a linearly varying rugate filter (e.g., having a spatially-varying refractive index based on porous oxides, such as silica). In some embodiments, the filter 313 may be a multi-stack or multi-cavity Fabry-Perot interferometer, which may be configured to transmit optical signals In one embodiment the filter may be a multi-stack Fabry-Perot filter. For such filters, the incoming emitter light from the emitters 315c may be provided with a collection of angles and in each angle, a different wavelength (e.g., λ1, λ2, λ3) will be transmitted by the filter 313.

In FIG. 3C, an example emitter-side filter 313 is illustrated as a Fabry-Perot interferometer including parallel reflecting surfaces 313s (e.g., illustrated as wedge-shaped optical flats or thin mirrors) defining one or more gaps 313g between the surfaces 313s and/or between the filter 313 and the emitter(s) 315c. The gap 313g varies across a surface of the emitter-side filter 313 facing the field of view 390. The emitter-side filter 313 may be configured to transmit emission wavelengths λ1, λ2, λ3 that vary as a function of position across the emission source (e.g., across an array of emitters 315c) and over corresponding portions of the field of view 390.

As shown in FIG. 3C, the spatially-varying bandpass filter 313 is configured to receive the optical signals having a first emission wavelength or wavelength range k from the emitter(s) 315c, and to output the respective optical signals with the respective wavelengths that vary (e.g., λ1, λ2, λ3) over the respective portions/field angles of the field of view 390 as a function of position along a surface of the spatially-varying bandpass filter 313 (e.g., relative to an optical axis 317 of the spatially-varying filter 313). For example, the optical signals output from the emitter(s) 315c may have a broadband emission wavelength range k, while the spatially-varying bandpass filter 313 may output respective optical signals having different narrowband emission wavelength ranges λ1, λ2, λ3 that vary along the surface of the filter 313 that is arranged to illuminate the FOV 390.

The gap or distance 313g between the one or more surfaces 313s of the spatially-varying bandpass filter 313 may be non-uniform along an interface therebetween to provide the variation in emission wavelength over the range of λ1 to λ3 while reducing or preventing back-reflection into optical cavity of the emitter(s) 315c. The wavelengths λ1 to λ3 of light emission may thereby vary as a function of position (along the surface of the spatially-varying bandpass filter 313) and angle (relative to the optical axis 317), such that different wavelengths of light reflected from targets at respective portions or angles of the field of view 390 are received by the detection-side optical elements at respective angles of incidence that correspond to variations in a passband of a detector-side spectral filter element over the angles or portions of the field of view 390. In some embodiments, mechanically-implemented emission variation (e.g., as provided by the emitter array 315 of FIG. 3A) may be combined with optically-implemented emission variation (e.g., as provided by the filter 313 of FIG. 3B) such that the discrete or stepwise emission variation of the optical signals emitted from the emitter array 315 may be further varied over the FOV 390 by the spatially varying bandpass filter 313.

FIGS. 4A and 4B illustrate example implementations of a detector-side filter element 411 and one or more detectors 410d that are configured to image the field of view 490 in accordance with some embodiments described herein. The detectors 110d and detector-side filter 411 may include or otherwise represent the detectors 110d and filter 111 of FIG. 1. For example, the detectors 410d may be arranged in an array, such as the detector array 110 of FIG. 1.

As shown in FIG. 4A, a spectral filter 411 is provided in an optical path of the detectors 410d, and is configured to transmit light having wavelengths within a passband of the filter 411 to the detector(s) 410d. As the passband of the detector-side filter 411 may vary with the angle of incidence of light thereon (e.g., relative to the optical axis 418 of the detection-side optical elements), the emission sources described herein (for example, as described above with reference to FIGS. 3A and 3B) direct optical signals having different wavelengths (for example, wavelengths λ1 to λ3) over respective field angles, such that echo signals from targets that are located in portions of the FOV 490 corresponding to the field angles are received at angles of incidence that correspond to the variations in the passband of the detector-side filter 411 (i.e., so as to match the changes in the passband with angle of incidence of the detector-side filter 411 for the respective field angles).

As shown in FIG. 4B, detector-side filter elements 411 according to embodiments of the present disclosure may thereby be configured to selectively accept (permit or allow passage therethrough) or reject (block or prevent passage therethrough) optical signals based on both wavelength (shown with reference to two wavelengths λ1 and λ2 for ease of illustration) and direction or angle of incidence (e.g., relative to the optical axis 418 of the detection module). In the example of FIG. 4B, the detector-side filter 411 is configured to transmit echo signals of a first wavelength λ1 when received or incident from central portions or angles of the field of view, and is configured to transmit echo signals of a second wavelength λ2 when received or incident from peripheral portions or angles of the field of view. Conversely, the detector-side filter 411 is configured to block echo signals of the first wavelength λ1 when received or incident from the peripheral portions or angles of the field of view, and is configured to block echo signals of the second wavelength λ2 when received or incident from the central portions or angles of the field of view. Detector-side filter elements 411 in accordance with embodiments of the present disclosure may thereby be used to provide direction- and wavelength-based elimination of multipath, as described below with reference to FIG. 5.

FIG. 5 is a block diagram illustrating an example application of active illumination systems including emission sources and detection modules that are configured to operate based on field angle- or position-dependent variation in emission wavelength in accordance with some embodiments of the present disclosure. In particular, as the emission sources may be configured to output optical signals with respective emission wavelengths that vary over respective portions or angles of the field of view, the detection modules may correspondingly be configured to selectively accept or reject echo signals of the respective emission wavelengths that are received from those respective portions or angles of the field of view, which may be used to address multipath. For example, if the lidar system 100 illuminates an object 150 which is in the general vicinity of a reflective surface 550 (e.g., a window), the light reflected from the object 150 may be directed to the surface 550 (which may be positioned in the field of view at a different azimuth than the object 150) and then reflected back to the lidar system 100. Absent emission sources and detection modules in accordance with embodiments of the present disclosure, a lidar system may thereby determine that the object 150 is in the direction of the reflective surface 550 and is located at a farther distance than the actual distance between the object 150 and the lidar system.

In contrast, embodiments of the present disclosure provide active illumination-based imaging systems 100 with detector modules that are configured to selectively reject optical signals of particular wavelengths when received from portions or angles of the field of view that differ from or otherwise do not correspond to the portions or angles of the field of view illuminated by the emission source with optical signals of those particular wavelengths. That is, the detector-side filter may be configured to reject optical signals of a wavelength emitted towards a central portion of the field of view if received or incident from a peripheral portion of the field of view (or vice versa), thus reducing or preventing multipath issues.

In particular, as shown in the example of FIG. 5, optical signals having a first wavelength λ1 are directed towards a first (e.g., central) portion or angle of a field of view where object 150 (illustrated as a car by way of example) is located, while optical signals having a second wavelength λ2 are directed towards a second (e.g., peripheral) portion or angle of the field of view where another reflective surface 550 (illustrated as a highly-reflective building) is located. Reflections of the illuminated light or echo signals having the first wavelength λ1 are reflected from the car 150 and returned to the lidar system 100, and may thereby be used by the lidar system 100 to correctly measure the direction and distance of the car 150. In particular, the detector-side filter of the lidar system 100 is configured to accept light of the first wavelength λ1 when received from a central portion or angle of the field of view. However, some of the reflected light of the first wavelength (indicated as λ1′) is redirected to the building 550 before being reflected to the lidar system 100 from the peripheral portion or angle of the field of view. In the absence of embodiments of the present disclosure, a lidar system may identify an object in the peripheral portion in the field of view in the direction of the building 550, and at a range farther than the car 150 and/or the building 550. However, in the lidar system 100 including active illumination-based imaging in accordance with embodiments of the present disclosure, the detector-side filter is configured to accept optical signals of the second wavelength λ2 that are incident from the peripheral portions or angles of the field of view, but is configured to reject (illustrated by “X”) optical signals of the first wavelength λ1′ that are incident from the peripheral portions or angles of the field of view, so as to block the multi-path light λ1′.

Active illumination-based imaging systems described herein can likewise be used in other applications. For example, active illumination systems including emission sources and detection modules that are configured to operate based on field angle- or position-dependent variation in emission wavelength can be used for interference mitigation. In particular, as the detection module images only a specific, relatively narrowband wavelength range in each direction or portion of the field of view, the likelihood of detection of optical signals from other illumination (e.g., another active illumination system) may be significantly reduced.

As another example application, detection modules that are configured to operate based on field angle- or position-dependent variation in emission wavelength as described herein can be used for anti-active-interference. In particular, by only imaging a specific, relatively narrowband wavelength range in each direction or portion of the field of view, detection modules as described herein may be configured to reduce or prevent active interference (e.g., from an illumination source intended to ‘blind’ the detection module by emitting energy in the operational wavelength range toward the detection module). Such anti-active interference may be used, for example, in military applications.

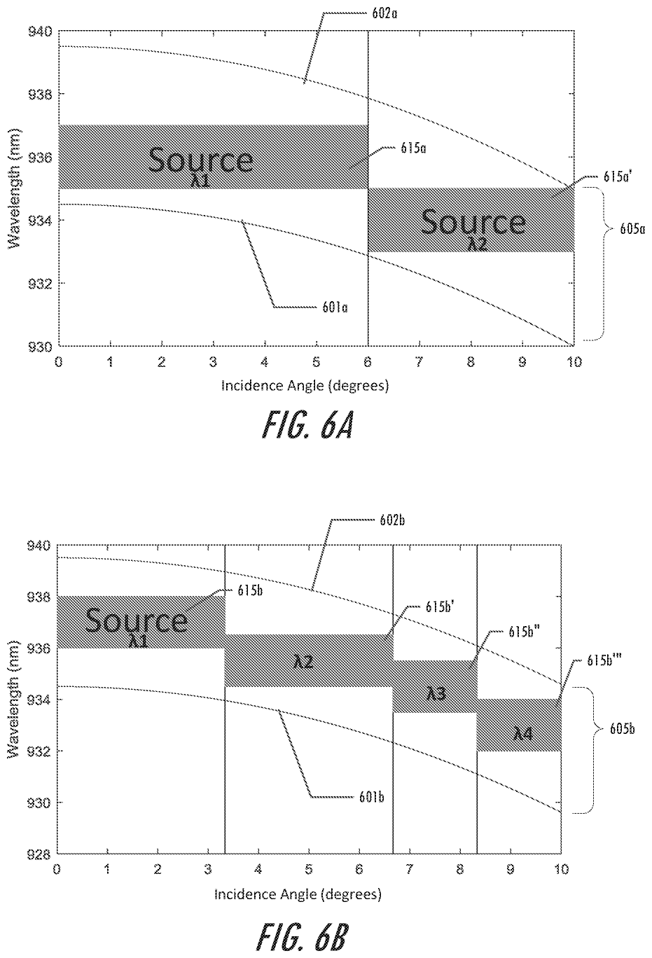

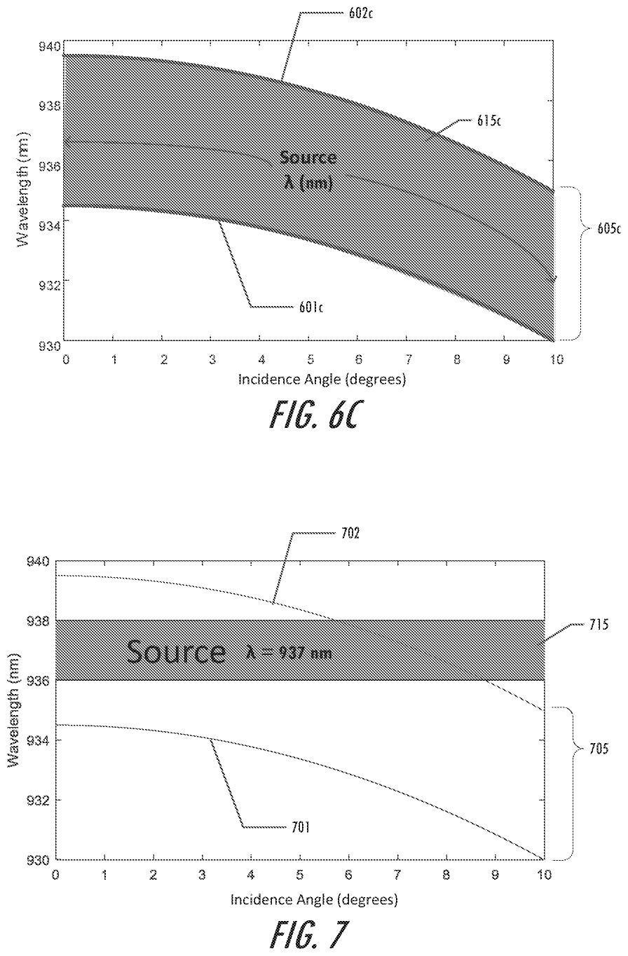

FIG. 6A is a graph illustrating example passband characteristics of a detector-side filter (such as the filters 111 or 411 described herein) when operated in coordination with emission sources in accordance with some embodiments of the present disclosure. The detector-side filter of FIG. 6A may be similar to the filter discussed with reference to FIG. 7, with the area between the lower curve 601a (the cut on wavelength) and the upper curve 602a (the cut off wavelength) illustrating the changes in passband 605a of the detector-side filter with angle of incidence over a range of 0 to 10 degrees.

As shown in the example of FIG. 6A, a detector-side filter has a passband 605a of about 5 nanometers (nm) (defined between lower curve/cut on wavelength 601a and upper curve/cut off wavelength 602a) that is centered on 937 nm at an incident angle of 0 degrees. In FIG. 6A, the emission source is configured to vary the emission wavelength of optical signals 615a, 615a′ over the field of view in accordance with embodiments described herein. In particular, the emission source illustrated in FIG. 6A emits optical signals 615a having a first emission wavelength or range λ1 (with a center wavelength of about 936 nm) over angles of the field of view corresponding to detector-side filter angles of incidence (that is, at field angles such that echo signals are incident on a surface of the detector-side filter, relative to its optical axis) between 0 and about 6 degrees, and optical signals 615a′ having a second emission wavelength or range λ2 (with a center wavelength of about 934 nm) for detector-side filter angles of incidence between about 6 and 10 degrees. In comparison to the light emission 715 of FIG. 7, the emission sources in accordance with some embodiments described herein may thereby provide light emission 615a, 615a′ that varies with field angle based on the actual or expected changes in the passband 605a of the detector-side filter, such that detection of signal light reflected from targets is maintained over the FOV even with the changes in the detector-side filter passband.

FIG. 6B is a graph illustrating example passband characteristics of a detector-side filter (such as the filters 111 or 411 described herein) when operated in coordination with emission sources in accordance with some further embodiments of the present disclosure. In particular, the detector-side filter of FIG. 6B may have a passband 605b defined between lower curve/cut on wavelength 601b and upper curve/cut off wavelength 602b similar to the filter of FIG. 6A, but is used in conjunction with an emission source in accordance with embodiments described herein that is configured to provide more variations in the emission wavelengths over the respective angle zones or field angles.

In particular, the emission source illustrated in FIG. 6B emits optical signals 615b, 615b′, 615b″, 615b″ having a first emission wavelength or range λ1 (with a center wavelength of about 937 nm) over angles of the field of view corresponding to detector-side filter angles of incidence between 0 and about 3.5 degrees; a second emission wavelength or range λ2 (with a center wavelength of about 935 nm) over angles of the field of view corresponding to detector-side filter angles of incidence between about 3.5 degrees and 6.5 degrees; a third emission wavelength or range λ3 (with a center wavelength of about 934 nm) over angles of the field of view corresponding to detector-side filter angles of incidence between about 6.5 degrees and 8.5 degrees; and a fourth emission wavelength or range λ4 (with a center wavelength of about 933 nm) over angles of the field of view corresponding to detector-side filter angles of incidence between about 8.5 degrees and 10 degrees. As shown in FIG. 6B, the respective optical signals output by emission sources in accordance with embodiments described herein may have respective emission wavelength ranges for λ1, λ2, λ3, and/or λ4 that both vary with field angle and overlap (e.g., by about 1 nm or less in some embodiments) based on the actual or expected changes in the passband 605b of the detector-side filter.

FIG. 6C is a graph illustrating example passband characteristics of a detector-side filter (such as the filters 111 or 411 described herein) when operated in coordination with emission sources in accordance with yet further embodiments of the present disclosure. In particular, the detector-side filter of FIG. 6C may have a passband 605c defined between lower curve/cut on wavelength 601c and upper curve/cut off wavelength 602c similar to the filter of FIG. 6B. The passband 605c is configured to correspond to variations in emission wavelength λ of optical signals 615c provided by an emission source over the respective field angles. That is, the emission source may be configured to output optical signals with wavelengths that continuously change as a function of direction over the field of view, and the passband defined between the cut on wavelength 601c and the cut off wavelength 602c of the detector-side filter may likewise be configured to transmit light having the same wavelengths per direction as the optical signals 615c output from the emission source.

Accordingly, in some embodiments of the present disclosure, active illumination systems and related methods of operation include an emission source including one or more emitter elements configured to illuminate a FOV, and a control circuit configured to control operation of the emission source. The emission source is configured to output the optical signals with respective wavelengths that vary based on respective portions or angles of the field of view (for example, with a first wavelength at central angles of the field of view, and a second wavelength that is different from the first wavelength a peripheral angles of the field of view) to provide angle-dependent variation in emission wavelength. In some embodiments, the respective wavelengths of the optical signals output over respective field angles or angular ranges of the FOV correspond to changes in the optical characteristics of a detection module (e.g., the passband of a detector-side spectral filter element in the optical path of one or more detector elements) that images the respective field angles or angular ranges of the FOV. The respective wavelengths may decrease in a stepwise or continuous fashion from a central angle of the field of view to peripheral angles of the field of view.

In some embodiments, an emitter array is configured to output optical signals having different wavelengths over different angles of the field of view. The emitter array may include emitters from different bins or otherwise having different emission wavelengths attached to a common substrate (at respective spatial positions based on the different emission wavelengths) and electrically interconnected. The emitters may have a spatial arrangement on the substrate such that respective wavelengths of the optical signals output over respective field angles or angular ranges of the FOV correspond to changes in the passband of the detector-side spectral filter element that images the respective field angles or angular ranges of the FOV.

In some embodiments, the emitter array may include an array of light emitting diodes or an array of VCSELs. In some embodiments, the emitter array may include an array of side- or edge-emitting laser diodes. For VCSELs or LEDs, in some embodiments, the respective emission wavelengths are mapped to the emitter elements on-wafer or otherwise at wafer level (i.e., before dicing or singulation).

In some embodiments, a spatially-varying bandpass filter element is inserted or otherwise provided in the optical path of the emitter array. The one or more emitters may be one or more broadband light sources. In some embodiments, a gap or distance between one or more elements of the spatially-varying bandpass filter element may be variable or non-uniform along the interface therebetween or otherwise along the surface of the emitter array, and the filter may be configured to transmit the optical signals with the respective wavelengths that vary as a function of position across the array such that respective wavelengths of the optical signals output over respective field angles or angular ranges of the FOV correspond to changes in the passband of the detector-side spectral filter element that images the respective field angles or angular ranges of the FOV. In some embodiments, the spatially-varying bandpass filter element may be a Fabry-Perot interferometer with a gap which varies across the array.

In some embodiments a spectral filter element is inserted or otherwise provided in the optical path of a detector or detector array that is configured to image the field of view, such that sufficient background light is removed to enable a sufficiently high signal-to-noise ratio in the ToF sensor. The detector array may include one or more detector elements that are configured to output respective detection signals responsive to light provided thereto by the spectral filter element.

In some embodiments, the detector-side spectral filter element may be a band pass filter containing the emission wavelength. That is, the spectral filter element may be configured to permit light of a wavelength range containing the respective wavelengths of the optical signals output from the lidar emitter elements to pass therethrough to the detector array, and reduce or block or prevent passage of optical signals having wavelengths other than the respective wavelengths output from the emitter elements. The spectral filter element may have substantially flat or planar surfaces, which may correspond to one or more surfaces of the detector. The passband of the spectral filter element may vary with angle of incidence of the light thereon, and the respective wavelengths that vary over the respective portions of the field of view may spatially correspond to the passband of the spectral filter element based on the respective portions of the field of view to which they are directed.

In some embodiments, one or more control circuit(s) may be configured to provide the variation in emission wavelength of the emission source over respective portions or angles of the field of view. For example, one or more control circuits may be configured to control the temperature at one or more regions of the emission source (e.g., at individual rows and/or columns of an emitter array) to provide a desired wavelength shift (e.g., a temperature-dependent wavelength shift of the optical signals output from the emitters positioned at the respective regions) for corresponding portions or angles of the field of view. For example, heating and/or cooling elements (e.g., thermoelectric elements) may be provided at one or more regions of the emission source and actively controlled responsive to signals from the control circuit(s) to alter the respective temperatures and/or provide a temperature gradient between regions. In some embodiments, the control circuit(s) may be configured to individually control the temperature of each emitter. In some embodiments, the control circuit(s) may be configured to maintain a substantially constant baseline temperature at a first region of an emitter array, and to provide a temperature gradient from the first region to one or more other regions of the emitter array. In some embodiments, a baseline temperature of the emission source may be permitted to drift, but the control circuit(s) may be configured to control the temperature gradient from the baseline temperature, and may be further configured to control the passband characteristics of the detection module (e.g., by controlling the center wavelength or wavelength at normal incidence) of the detector-side filter element (e.g., by controlling the temperature of the detector-side filter) to track the temperature-dependent baseline-emitter wavelength.

Some benefits of emission sources that provide illumination wavelength variation with field angle in accordance with embodiments described herein may include reduction in the size and/or cost of the imaging optics for an active-illumination imaging system that may attenuate background light using detector-side spectral filtering. Particular embodiments described herein may be thus provide advantages in operation of systems that include a filter to reduce background light, while reducing and/or avoiding attenuation of the radiation from the emission source.

Lidar systems and arrays described herein may be applied to ADAS (Advanced Driver Assistance Systems), autonomous vehicles, UAVs (unmanned aerial vehicles), industrial automation, robotics, biometrics, modeling, augmented and virtual reality, 3D mapping, and security. In some embodiments, the emitter elements of the emitter array may be vertical cavity surface emitting lasers (VCSELs). In some embodiments, the emitter array may include a non-native substrate having thousands of discrete emitter elements electrically connected in series and/or parallel thereon, with the driver circuit implemented by driver transistors integrated on the non-native substrate adjacent respective rows and/or columns of the emitter array, as described for example in U.S. Patent Application Publication No. 2018/0301872 to Burroughs et al.

Various embodiments have been described herein with reference to the accompanying drawings in which example embodiments are shown. These embodiments may, however, be embodied in different forms and should not be construed as limited to the embodiments set forth herein. Rather, these embodiments are provided so that this disclosure is thorough and complete and fully conveys the inventive concept to those skilled in the art. Various modifications to the example embodiments and the generic principles and features described herein will be readily apparent. In the drawings, the sizes and relative sizes of layers and regions are not shown to scale, and in some instances may be exaggerated for clarity.

The example embodiments are mainly described in terms of particular methods and devices provided in particular implementations. However, the methods and devices may operate effectively in other implementations. Phrases such as “example embodiment”, “one embodiment” and “another embodiment” may refer to the same or different embodiments as well as to multiple embodiments. The embodiments will be described with respect to systems and/or devices having certain components. However, the systems and/or devices may include fewer or additional components than those shown, and variations in the arrangement and type of the components may be made without departing from the scope of the inventive concepts. The example embodiments will also be described in the context of particular methods having certain steps or operations. However, the methods and devices may operate effectively for other methods having different and/or additional steps/operations and steps/operations in different orders that are not inconsistent with the example embodiments. Thus, the present inventive concepts are not intended to be limited to the embodiments shown, but are to be accorded the widest scope consistent with the principles and features described herein.

It will be understood that when an element is referred to or illustrated as being “on,” “connected,” or “coupled” to another element, it can be directly on, connected, or coupled to the other element, or intervening elements may be present. In contrast, when an element is referred to as being “directly on,” “directly connected,” or “directly coupled” to another element, there are no intervening elements present.

It will also be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise.

It will also be understood that the term “and/or” as used herein refers to and encompasses any and all possible combinations of one or more of the associated listed items. It will be further understood that the terms “include,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, the regions illustrated in the figures are schematic in nature and their shapes are not intended to illustrate the actual shape of a region of a device and are not intended to limit the scope of the invention.

Unless otherwise defined, all terms used in disclosing embodiments of the invention, including technical and scientific terms, have the same meaning as commonly understood by one of ordinary skill in the art to which this invention belongs, and are not necessarily limited to the specific definitions known at the time of the present invention being described. Accordingly, these terms can include equivalent terms that are created after such time. It will be further understood that terms, such as those defined in commonly used dictionaries, should be interpreted as having a meaning that is consistent with their meaning in the present specification and in the context of the relevant art and will not be interpreted in an idealized or overly formal sense unless expressly so defined herein. All publications, patent applications, patents, and other references mentioned herein are incorporated by reference in their entireties.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments of the present invention described herein, and of the manner and process of making and using them, and shall support claims to any such combination or subcombination.

Although the invention has been described herein with reference to various embodiments, it will be appreciated that further variations and modifications may be made within the scope and spirit of the principles of the invention. Although specific terms are employed, they are used in a generic and descriptive sense only and not for purposes of limitation, the scope of the present invention being set forth in the following claims.

1. An active illumination apparatus, comprising:
an emission source configured to illuminate a field of view, the emission source comprising one or more emitter elements,
wherein the emission source is configured to output optical signals having respective wavelengths that vary based on respective portions of the field of view to be illuminated thereby.

2. The active illumination apparatus of claim 1, wherein the respective portions of the field of view comprise respective field angles, and wherein the respective wavelengths of the optical signals comprise a first wavelength at one or more central angles of the field angles, and a second wavelength that is greater than or less than the first wavelength at one or more peripheral angles of the field angles.

3. The active illumination apparatus of claim 2, wherein the respective wavelengths of the optical signals decrease in a stepwise or continuous fashion from the one or more central angles of the field angles to the one or more peripheral angles of the field angles.

4. The active illumination apparatus of claim 2, wherein the respective wavelengths of the optical signals vary according to variations in a passband of a detector-side spectral filter element that is configured to receive return signals having the respective wavelengths corresponding to the optical signals over the respective portions of the field of view.

5. The active illumination apparatus of claim 4, further comprising:
one or more detector elements that are configured to image the field of view; and
the detector-side spectral filter element, wherein the detector-side spectral filter element is in an optical path of the one or more detector elements and is configured to permit the return signals having the respective wavelengths that are within the passband thereof to the one or more detector elements.

6. The active illumination apparatus of claim 5, wherein the detector-side spectral filter element is configured to prevent interference with the return signals having the first wavelength that are incident thereon at the one or more central angles, and/or with the return signals having the second wavelength that are incident thereon at the one or more peripheral angles.

7. The active illumination apparatus of claim 6, wherein the detector-side spectral filter element is configured to block the return signals having the first wavelength that are incident thereon at the one or more peripheral angles, and is configured to block the return signals having the second wavelength that are incident thereon at the one or more central angles.

8. The active illumination apparatus of claim 1, wherein the emission source comprises:
an emitter array comprising a plurality of the emitter elements that are configured to emit the optical signals with the respective wavelengths that vary based on respective spatial locations of the emitter elements in the emitter array, wherein the respective spatial locations are arranged to illuminate the respective portions of the field of view.

9. The active illumination apparatus of claim 8, wherein the emitter array comprises a substrate that is non-native to the emitter elements, and the emitter elements are assembled on the substrate at the respective spatial locations based on the respective wavelengths of the optical signals.

10. The active illumination apparatus of claim 9, wherein the emitter elements are transfer-printed on the substrate, and at least one of the emitter elements comprises a residual tether portion.

11. The active illumination apparatus of claim 8, wherein each of the respective spatial locations comprises a subset of the emitter elements corresponding to a same bin or a same wavelength range based on the respective wavelengths of the optical signals.

12. The active illumination apparatus of claim 8, wherein the emitter elements comprise light emitting diodes or laser diodes, optionally wherein the laser diodes comprise vertical cavity surface emitting laser diodes and/or edge-emitting laser diodes.

13. The active illumination apparatus of claim 1, wherein the emission source comprises:
a filter element that is in an optical path of the one or more emitter elements and is configured to output the optical signals with the respective wavelengths that vary at respective positions along a surface of the filter element, wherein the respective positions are arranged to illuminate the respective portions of the field of view.

14. The active illumination apparatus of claim 13, wherein the one or more emitter elements comprise one or more broadband light sources that are configured to emit the optical signals having first wavelengths within a first wavelength range, and wherein the filter element is configured to output the optical signals having second wavelengths within respective second wavelength ranges that are narrower than the first wavelength range.

15. The active illumination apparatus of claim 13, wherein the filter element comprises a spatially varying bandpass filter defining a non-uniform gap between one or more components thereof along an interface with the one or more emitter elements.

16. A method of fabricating an active illumination apparatus, the method comprising:
providing an emission source that is configured to illuminate a field of view, the emission source comprising one or more emitter elements,
wherein the emission source is configured to output optical signals having respective wavelengths that vary based on respective portions of the field of view to be illuminated thereby.

17. The method of claim 16, wherein providing the emission source comprises:
forming an emitter array comprising a plurality of the emitter elements that are configured to emit the optical signals with the respective wavelengths that vary based on respective spatial locations of the emitter elements in the emitter array, wherein the respective spatial locations are arranged to illuminate the respective portions of the field of view.

18. The method of claim 17, wherein forming the emitter array comprises:
providing a substrate that is non-native to the emitter elements; and
assembling the emitter elements on the substrate at the respective spatial locations based on the respective wavelengths of the optical signals to be emitted thereby.

19. The method of claim 18, wherein assembling the emitter elements comprises transfer-printing the emitter elements on the substrate, and wherein at least one of the emitter elements comprises a residual tether portion.

20. The method of claim 18, wherein each of the respective spatial locations comprises a subset of the emitter elements corresponding to a same bin or a same wavelength range based on the respective wavelengths of the optical signals.

21. The method of claim 16, wherein providing the emission source comprises:
providing a filter element in an optical path of the one or more emitter elements, wherein the filter element is configured to output the optical signals with the respective wavelengths that vary at respective positions along a surface of the filter element, wherein the respective positions are arranged to illuminate the respective portions of the field of view.

22. The method of claim 21, wherein the one or more emitter elements comprise one or more broadband light sources that are configured to emit the optical signals having first wavelengths within a first wavelength range, and wherein the filter element is configured to output the optical signals having second wavelengths within respective second wavelength ranges that are narrower than the first wavelength range.

23. The method of claim 16, further comprising:
providing a detection module comprising one or more detector elements that are configured to receive return signals having the respective wavelengths corresponding to the optical signals over the respective portions of the field of view, and a detector-side spectral filter element in an optical path of the one or more detector elements,
wherein the respective wavelengths of the optical signals vary according to variations in a passband of the detector-side spectral filter element.

24. The method of claim 23, wherein:
the respective portions of the field of view comprise respective field angles;
the respective wavelengths of the optical signals comprise a first wavelength at one or more central angles of the field angles, and a second wavelength that is greater than or less than the first wavelength at one or more peripheral angles of the field angles; and
the detector-side spectral filter element is configured to block the return signals having the first wavelength that are incident thereon at the one or more peripheral angles, and is configured to block the return signals having the second wavelength that are incident thereon at the one or more central angles.

25. An active illumination-based imaging apparatus, comprising:
an emission source comprising one or more emitter elements configured to output optical signals to illuminate a field of view; and
a detection module comprising one or more detector elements configured to image the field of view,
wherein the emission source is configured to output the optical signals having respective wavelengths that vary over respective field angles of the field of view according to variations in optical characteristics of the detection module for the respective field angles.

26. The active illumination-based imaging apparatus of claim 25, wherein the respective wavelengths comprise a first wavelength at one or more central angles of the field angles, and a second wavelength that is greater than or less than the first wavelength at one or more peripheral angles of the field angles.

27. The active illumination-based imaging apparatus of claim 26, wherein the respective wavelengths decrease in a stepwise or continuous fashion from the one or more central angles of the field angles to the one or more peripheral angles of the field angles.

28. The active illumination-based imaging apparatus of claim 26, wherein the detection module further comprises:
a spectral filter element in an optical path of the one or more detector elements and configured to permit return signals having the respective wavelengths within a passband thereof to the one or more detector elements, and wherein the optical characteristics of the detection module comprise the passband of the spectral filter element for the respective field angles.

29. The active illumination-based imaging apparatus of claim 28, wherein the spectral filter element is configured to block the return signals having the first wavelength that are incident thereon at the one or more peripheral angles, and is configured to block the return signals having the second wavelength that are incident thereon at the one or more central angles.

30. The active illumination-based imaging apparatus of claim 25, wherein the emission source comprises:
an emitter array comprising a plurality of the emitter elements that are configured to emit the optical signals with the respective wavelengths that vary based on respective spatial locations of the emitter elements in the emitter array, wherein the respective spatial locations are arranged to illuminate the respective field angles.

31. The active illumination-based imaging apparatus of claim 25, wherein the emission source comprises:
a filter element that is in an optical path of the one or more emitter elements and is configured to output the optical signals with the respective wavelengths that vary at respective positions along a surface of the filter element, wherein the respective positions are arranged to illuminate the respective field angles.

32. The active-illumination based imaging apparatus of claim 25, further comprising:
at least one control circuit that is configured to control a temperature of the emission source to vary the respective wavelengths of the optical signals over the respective field angles, and/or to control a temperature of the detection module to provide the variations in the optical characteristics of the detection module for the respective field angles.
